(19) United States
(12) Patent Application Publication
(10) Pub. No.: US 2006/0277541 A1
(43) Pub. Date: Dec. 7, 2006

(54) Relocatable component file format

(75) Inventors: James Shannon Sproul, Foster City, CA (US); Paul deNyse Burrowes IV, Foster City, CA (US)

Correspondence Address: CARR & FERRELL LLP, 2200 GENG ROAD, PALO ALTO, CA, 94303, US

(73) Assignee: Sony Computer Entertainment America Inc.

(21) Appl. No.: 11/147,858

(22) Filed: Jun. 7, 2005

(51) Int. Cl. G06F 9/445

(52) U.S. Cl. 717/174

(57) ABSTRACT

Executable code and data are stored in a relocatable component file format (RCFF) to allow dynamic loading of executable code and data at runtime into memory accessible by a processor running an application program. A component manager manages access to the RCFF component and stores additional information within the RCFF component so that the RCFF component can be loaded, unloaded, and/or repeatedly relocated in memory. The application program desiring access to a function or data in the RCFF component passes the name of the RCFF component and the name of the function or data to the component manager. The component manager determines the location of the function or data, calculates the address of the function or data, and returns the address back to the application program. The application program calls the RCFF component through a function pointer or an indirection, depending on the language being used.

### BACKGROUND OF THE INVENTION

1. Field of the Invention

This invention relates generally to computing devices and relates more particularly to a relocatable component file format applicable in computing and similar devices.

2. Description of the Background Art

Application programs in computing systems are generally divided into code (instructions) and data. Typically, the application program is divided up into many code segments, each of which provides one or more functions. The many code segments are generally included in one or more code libraries. The functionality of the application program depends on the various code segments present in the code libraries.

To ease reference to various functions and data in the application program and code libraries, symbol names are generally used. Symbol names provide a means to assign an easily referenced (or, for the programmer, easily remembered) name to a particular location in the application program, such as a location where a variable is stored as data, or an entry point for a function.

The symbol names cannot be directly interpreted by the processor that executes the application program. Instead, the processor uses numeric memory addresses to access application program code and data. The numeric memory addresses are generated in the machine code of the processor by either static linking or dynamic linking.

In static linking, a compiler and linker convert symbol names from source code into numeric addresses in machine code. The compiler determines how to manage a reference to a symbol name in a source code file. If the compiler finds the location for the symbol name within the source code file, then the compiler directly resolves the location of the symbol name into a numeric memory address. Alternatively, if the compiler cannot find the location for the symbol name within the source code file, the symbol name is probably defined in another source code file. The compiler saves the symbol name as an imported reference in the object file, and the linker resolves the imported reference into a numeric memory address. In most cases, if the linker cannot find the location for the symbol name, it will report an error for the undefined symbol name.

FIG. 1 illustrates an application program 105 that incorporates individual libraries A 110-C 130. With static linking, the libraries A 110-C 130 become part of the application program 105. Conversely, with dynamically linked libraries A 110-C 130, the application program 105 and the libraries A 110-C 130 are separate entities in memory. At runtime, the application program 105 calls the functions or data found in the dynamically linked library A 110, library B 120, and library C 130.

When the libraries are statically linked in the prior art, there is no difference in the way the linker generates references to locations in memory in the machine code, whether the references are to locations within the application program or locations in one of the statically linked libraries. The application program and libraries are combined by the linker to form a single executable file.

One limitation with static linking is that once the libraries A 110-C 130 are loaded in memory, they must stay at their respective locations in memory. The libraries A 110-C 130 cannot be changed at runtime because the libraries A 110-C 130 are part of the same executable file as the application program 105. The libraries A 110-C 130 cannot be removed from memory if they are no longer needed, nor can the libraries A 110-C 130 be replaced with substitute libraries that perform similar operations using different methods or using different hardware subsystems. The libraries A 110-C 130 remain in memory, occupying usable memory space, even if the functions or data contained in the libraries A 110-C 130 are rarely or never used by the application program 105.

Some computing systems also support dynamic linking, for example with dynamically linked libraries (DLLs). Dynamic linking allows an undefined symbol name in a first executable module of the application program to be resolved at runtime with a numeric address taken from a second executable module which is resident in memory. However, dynamic linking must be supported by both the linker and the operating system running on the processor. The linker must store the dynamically-linked symbol name in the first executable module without reporting the undefined symbol name as an error. At runtime, the operating system must resolve the dynamically-linked symbol name when the first executable module is loaded, and “fixup” the machine code accordingly. The term fixup refers to modifying machine code instructions that refer to absolute addresses in memory according to the actual runtime addresses they refer to, a process also referred to as “relocation”.

If dynamically linked libraries are used in FIG. 1, then the application program 105 and each library A 110-C 130 are separate executable files, loaded and linked to each other at runtime by the operating system. Dynamically linked libraries have advantages over statically linked libraries in that their functions and data can be shared by multiple resident application programs, and they can be unloaded from memory when they are no longer required. These attributes contribute to a relatively more efficient use of available memory space.

A limitation of dynamically linked libraries, as implemented in the prior art, is that unloading dynamically linked libraries from memory can lead to fragmentation of the memory heap with many processor architectures. Fragmentation of the memory heap can lead to a failure to load additional application programs or data because a contiguous block of memory may not be large enough to accommodate the additional application programs or data, even though the total size of unallocated free blocks of memory may be large enough in the aggregate to accommodate the additional application programs or data.

The traditional approach is to consolidate the free blocks of memory into a single block, moving the allocated blocks together in a process known as “heap compaction”. However, if an allocated block of memory contains machine code instructions, as with a dynamically linked library, then the block of memory cannot be moved to consolidate free memory because information required to repeat the dynamic linkage fixup process is either removed from memory or overwritten when the library is originally loaded and linked. A further limitation is that conflicts between various versions of DLLs and/or unnecessary copies of different versions of DLLs can prevent the application program from executing properly, a situation commonly referred to as “DLL hell.”

Symbol names present other limitations when dealing with relocatable components. Typically, a symbol name is represented as a variable length string of characters. Each character string can require a relatively large amount of memory space. This limitation is exacerbated if many symbol names are used in the application program. Further, comparing character strings at runtime can take many processor cycles, which can slow down the speed of execution of the application program. In the prior art, limitations associated with symbol names in dynamically linked libraries are generally accepted, since the symbol name character strings are only parsed when the library is linked to an application. Once the addresses associated with the symbol names have been resolved, and the affected machine code instructions have been “fixed up”, the symbol names need not be referred to again.

### SUMMARY OF THE INVENTION

In accordance with the invention, a method comprises calling a component in a calling function of an application program executing on a processor, passing information related to the component to a component manager, determining the location of the component in a memory coupled to the processor, and returning the location of the component to the calling function. The method may include relocating the component in the memory before determining the location of the component, and may include loading a second component into the memory. Relocating the component may comprise defragmenting the memory. The component may comprise initialized and uninitialized data.

An alternative method in accordance with the invention comprises calling, in a calling function of an application program executing on a processor, a reference within a component, passing information related to the component to a component manager, determining the location of the reference, and returning the location of the reference to the calling function. Calling the reference may comprise calling a symbol name and determining the location of the reference may comprise comparing the symbol name to a symbolic identifier associated with the symbol name. The symbolic identifier may comprise a cyclic redundancy check code. The location of the reference may be determined based upon an address for the component and an offset from the address to the reference

A system in accordance with the invention comprises a memory, a processor configured to execute an application program stored in the memory, and a component manager. The application program includes a calling function configured to call a component stored in the memory, and the component manager is configured to determine a memory address of the component and return the memory address to the calling function. The component manager may be further configured to relocate the component in the memory, load the component into the memory, defragment the memory, and/or prevent another application program from moving the component in memory.

### BRIEF DESCRIPTION OF THE DRAWINGS

FIG. 1 illustrates an application program that incorporates individual libraries which are statically linked in the prior art;

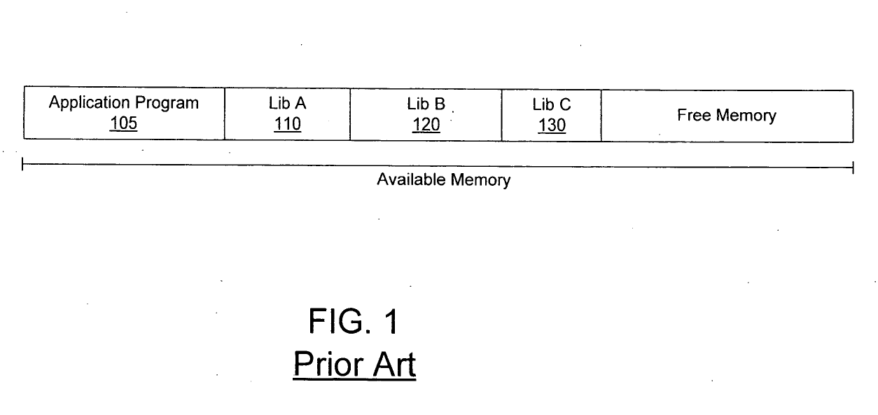

FIG. 2 is a block diagram of one embodiment of an electronic entertainment system in accordance with the invention;

FIG. 3 illustrates the main memory of FIG. 2, in one embodiment in accordance with the present invention;

FIG. 4 illustrates the main memory of FIG. 2 including the audio information module of FIG. 3 along with several RCFF components and a component manager, in an alternative embodiment in accordance with the present invention;

FIG. 5 illustrates a method by which the audio information module calls the RCFF component by using the component manager of FIG. 4, in one embodiment in accordance with the present invention;

FIG. 6 illustrates further detail of the RCFF component of FIG. 4, in one embodiment in accordance with the present invention;

FIG. 7 illustrates the component manager of FIG. 4, in one embodiment in accordance with the present invention; and

FIG. 8 illustrates a method for loading and running the RCFF component using the component manager of FIG. 4, in one embodiment in accordance with the present invention.

### DETAILED DESCRIPTION

Generally, executable code and data are stored in a relocatable component file format (RCFF) to allow dynamic loading of executable code and data at runtime into memory accessible by a processor running an application program. A component manager manages access to the RCFF component and stores additional information within the RCFF component so that the RCFF component can be loaded, unloaded, and/or repeatedly relocated in memory. The application program desiring access to a function or data in the RCFF component passes the name of the RCFF component and the name of the function or data to the component manager. The component manager determines the location of the function or data, calculates the address of the function or data, and returns the address back to the application program. The application program calls the RCFF component through a function pointer or an indirection, depending on the language being used. In an alternative embodiment, the application program may determine the location of the function or data within the RCFF component, and may relocate the RCFF component within memory. The application program may also coordinate the location of the RCFF component with the component manager so that other application programs or RCFF components may access the RCFF component.

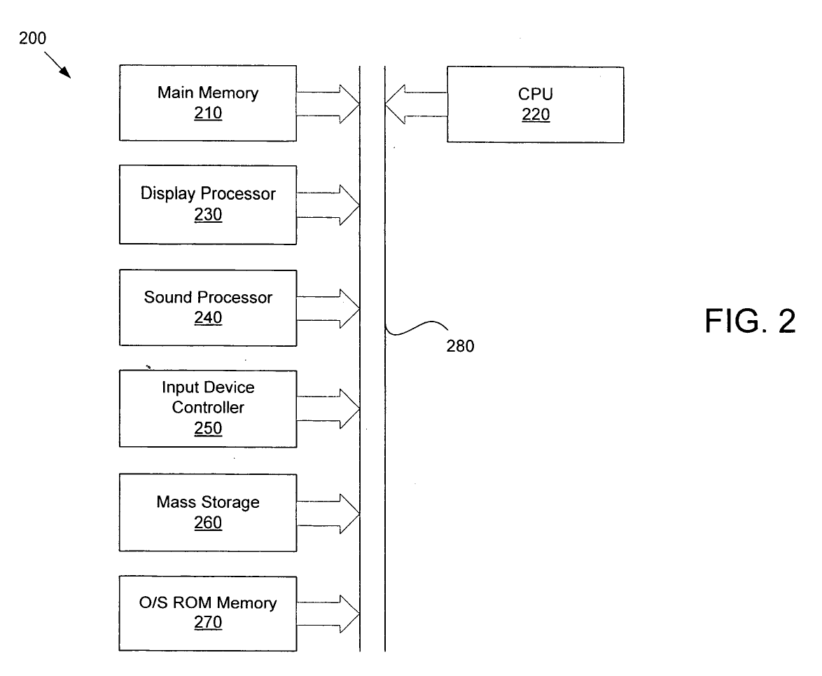

FIG. 2 is a block diagram of one embodiment of an electronic entertainment system 200 in accordance with the invention. The system 200 includes, but is not limited to, a main memory 210 (e.g., 128 MB), a central processing unit (CPU) 220, a video display processor 230, a sound processor 240, an input device (e.g., “joystick”) controller 250, a mass storage device (e.g., optical or magnetic disk drive) 260, and an operating system read-only memory 270. A digital bus 280 allows the devices 210-270 to communicate with each other, for example by sharing address and data information. The system 200 of this exemplary embodiment comprises an electronic gaming console, however, aspects of the invention are applicable to generic computing platforms. For example, the system 200 may comprise a general-purpose computer, a set-top box, or a hand-held gaming device.

In the electronic gaming console embodiment of the system 200, a user of the system 200 provides input to an application program executing on the CPU 220 by way of the input device controller 250 (e.g., via a keyboard, game controller or joystick, not shown). The display processor 230 receives instructions from the CPU 220 and accesses the main memory 210 to generate a graphical video image on a video monitor (not shown). The sound processor 240 receives instructions from the CPU 220 and accesses the main memory 210 to generate an audio signal (e.g., to a stereo sound reproduction system, not shown).

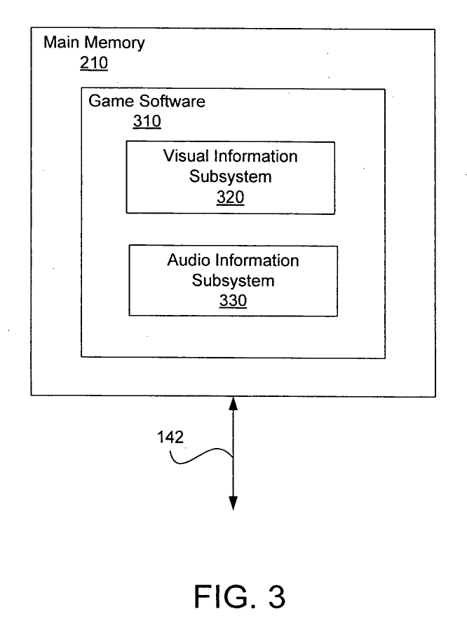

FIG. 3 illustrates the main memory 210 of FIG. 2, in one embodiment in accordance with the present invention. The main memory 210 includes, but is not limited to, game software 310 loaded into the main memory 210 from the mass storage device 260. The game software 310 includes instructions executable by the CPU 220 that allow the user of the system 200 to play in a game environment. For example, the game software 310 may comprise an action-adventure game in which the user controls a character on a journey through various levels of the game environment.

The game software 310 includes, but is not limited to, application programs such as a visual information subsystem 320 and an audio information subsystem 330. The visual information subsystem 320 is configured to visually provide game information to the user within the context of the game environment. For example, the visual information subsystem 320 may modify the character of the game in response to commands of the user. The audio information subsystem 330 is configured to audibly provide game information to the user within the context of the game environment. As described further herein, the visual information subsystem 320 and/or the audio information subsystem 330 are further configured to respond to the user of the system 200 in a manner that is interactive. For example, the audio information subsystem 330 may provide a variety of sounds in response to the actions of the user.

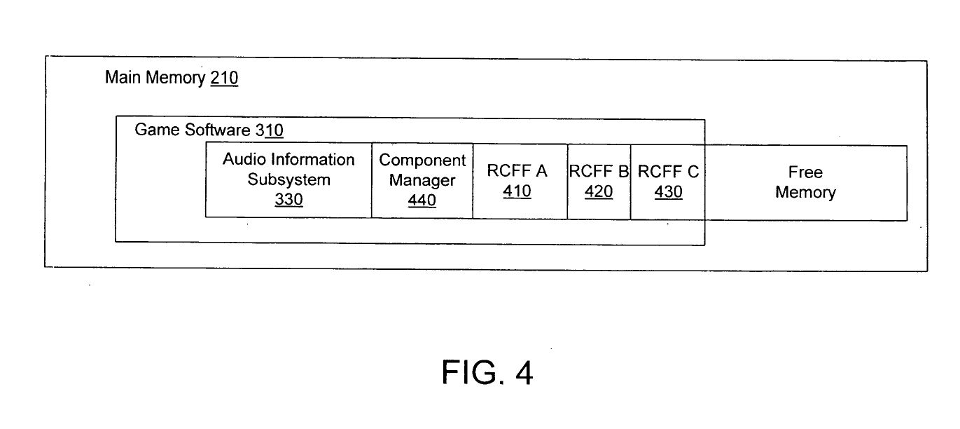

FIG. 4 illustrates the main memory 210 of FIG. 2 including the audio information subsystem 330 of FIG. 3 along with several RCFF components A 410-C 430 and a component manager 440, in an alternative embodiment in accordance with the present invention. For ease of illustration and explanation the visual information subsystem 320 and other subsystems of the game software 310, as well as their respective RCFF components, are not depicted. Further, although only three RCFF components A 410-C 430 are shown for simplicity of explanation, the number of RCFF components that may be present in the main memory 210 is limited only by the available space in the main memory 210.

As described further herein, the component manager 440 is statically linked to the audio information subsystem 330, and the RCFF components A 410-C 430 are separate executable files that are loosely linked to the audio information subsystem 330 at runtime. In one embodiment, the RCFF components A 410-C 430 include portions of program code which are required to create and control differing types of sound effects. For example, the RCFF component A 410 might comprise program code for creating and controlling an interactive car engine sound, while the RCFF component B 420 may comprise program code required to play background music based on the MIDI file format, and the RCFF component C 430 may comprise program code to play simple sound effects based on ADPCM compressed wavesamples. The RCFF components A 410-C 430 may be loaded into the main memory 210 and dynamically linked to the audio information subsystem 330 when the need arises for the type of sound each of the RCFF components A 410-C 430 create and control, and unloaded when no longer required.

As described further herein, the RCFF components A 410-C 430 each include one or more symbol names which are resolved at runtime. The component manager 440 may modify machine code instructions within the RCFF components A 410-C 430 during the fixup process, and keeps track of the locations of the RCFF components A 410-C 430 within memory so that each of the RCFF components A 410-C 430 may be readily relocated within memory by the component manager 440. Because of the component manager 440, the audio information subsystem 330 and external functions that call the audio information subsystem 330 may be unaware of the location within the main memory 210 of the RCFF components A 410-C 430 or the location of the functions or data within the RCFF components A 410-C 430. Generally, the audio information subsystem 330 accesses the RCFF components A 410-C 430 by first calling the component manager 440 to determine the location of the functions or data within the RCFF components A 410-C 430.

In another example, there may be five different varieties of joysticks available to be used in the system 200, in which each of the joysticks has a different “fire” button configuration. At initialization after power up, the system 200 determines which of the joysticks is connected to the system 200, through autonomous detection or through a configuration menu presented on the display. For example, a steering wheel controller may be connected to the system 200. The game software 310 may be programmed to perform a particular operation based upon the pressing of the fire button.

Rather than programming the game software 310 to determine whether the fire button was pressed for each of the five available joysticks in the system 200, RCFF components A-E (not shown) may be included in the game software 310 corresponding to each of the different joysticks. The appropriate RCFF component (e.g., RCFF component A) is loaded and linked according to whichever joystick is detected or selected. Accordingly, the game software 310 includes a single calling convention for a function that determines whether a fire button has been pressed. The RCFF component A is given a uniform name within the component manager 440, regardless of which of the RCFF components A-E is actually loaded. The function calling the RCFF component A need not be aware of which joystick is actually attached to the system 200, nor which of the RCFF components A-E is actually loaded. In this example, only the RCFF component A required for the selected joystick is loaded and resident in the main memory 210, and the RCFF components B-E associated with joysticks not selected are not loaded in the main memory 210.

For example, the RCFF components A-E each include a function called “getbuttons” that determines the status of the fire button. The function “gamecon” in the game software 310 calls the resident RCFF component A loaded from the available RCFF components A-E based on the joystick that is connected to the system 200. The RCFF component A is loaded into the main memory 210 by the component manager 440, dynamically linked to the game software 310, and given the reference name “joystick_comp”. The gamecon function in the game software 310 calls the component manager 440 and requests the address of the getbuttons function in the RCFF component joystick_comp. The component manager 440 returns the address of the getbuttons function in the RCFF component A through a function pointer, the RCFF component A retrieves the status of the fire button on the controller, and returns the fire button status to the game software 310.

An advantage of the architecture of FIG. 4 is that the component manager 440 may save space within the main memory 210, because the game software 310 may not need access to all of the RCFF components A 410-C 430 at the same time. Because the component manager 440 manages the locations of the RCFF components A 410-C 430 within the main memory 210, the component manager 440 may load and unload certain of the RCFF components A 410-C 430 based upon the functions that are needed by the game software 310. Further, the game software 310 need not maintain “awareness” of the location within memory of the RCFF components A 410-C 430.

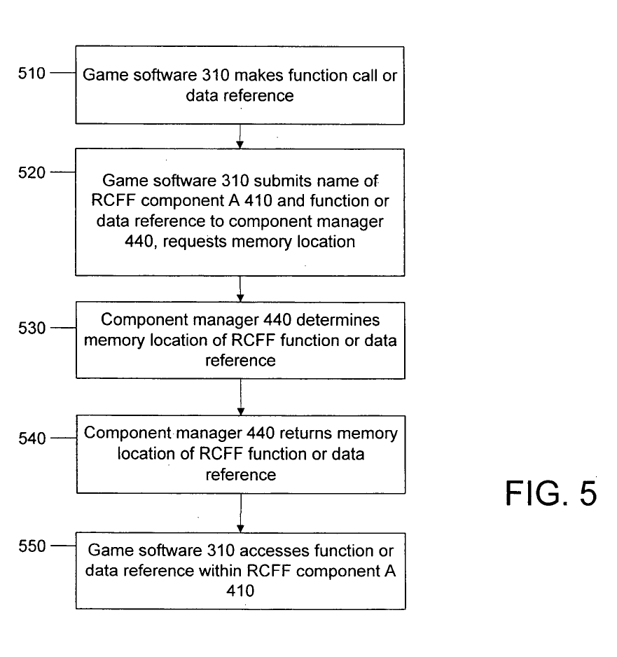

FIG. 5 illustrates a method by which the game software 310 calls the RCFF component A 410 by using the component manager 440 of FIG 4, in one embodiment in accordance with the present invention. At runtime at step 510, a calling function of the game software 310 makes a function call or data reference to the RCFF component A 410. At step 520, the game software 310 passes the name of the RCFF component A 410 and the name of the function or data reference within the RCFF component A 410 to the component manager 440. The game software 310 requests the address of the function or data reference within the RCFF component A 410 from the component manager 440.

At step 530, the component manager 440 determines the current location of the RCFF component A 410 in the main memory 210 and calculates the current address of the function or data reference within the RCFF component A 410. As described further herein, the component manager 440 determines the location of the RCFF component A 410 and matches the function or data reference to a 32-bit CRC (cyclic redundancy check) code associated with the function or data reference. The CRC code is stored in a table within the RCFF component A 410. To calculate the location in the main memory 210 at runtime, the component manager 440. determines the offset stored in the table within the RCFF component A 410, and calculates the base address plus the offset as the actual address of the function or data.

At step 540, the component manager 440 returns the address of the function or data reference to the game software 310. At step 550, the game software 310 calls the function or data reference within the RCFF component A 410 through a function pointer or an indirection (depending on the language being used by the processor, e.g., the CPU 220).

In an alternative embodiment to that described with respect to FIG. 5, the game software 310 may manage the memory location of the RCFF component A 410, obviating the need to pass requests for the location of the RCFF component A 410 to the component manager 440. Managing the memory location of the RCFF component A 410 may allow the game software 310 to operate faster, for example.

However, if the game software 310 manages the memory location of the RCFF component A 410, the game software 310 preferably sends information to the component manager 440 when the RCFF component A 410 is initially loaded into the main memory 210, and when the RCFF component A 410 is relocated. The information allows the component manager 440 to maintain a directory of locations in the main memory 210 for RCFF components, to coordinate use of the main memory 210, and to centralize the tasks of performing machine code fixups and calculation of function and data addresses within the component manager 440.

An advantage of the architecture of FIG. 4 and the method of FIG. 5 is that one or more of the RCFF components A 410-C 430 may be loaded, unloaded, or moved within the main memory 210 by the component manager 440 to make room for other components (not shown) needed by the game software 310. For example, as the user progresses from a first game level to a second game level of the game software 310, the component manager 440 may make contiguous memory space available for other RCFF components associated with the second game level. The component manager 440 may essentially defragment the main memory 210 and free up portions of the main memory 210. An advantage of utilizing the RCFF components A 410-C 430 and the component manager 440 is optimal use of the main memory 210, which may make possible reduced memory requirements for the main memory 210. A further advantage of utilizing the RCFF components A 410-C 430 and the component manager 440 in such fashion is that programmers of the second game level need not coordinate memory resource requirements with programmers of the first game level.

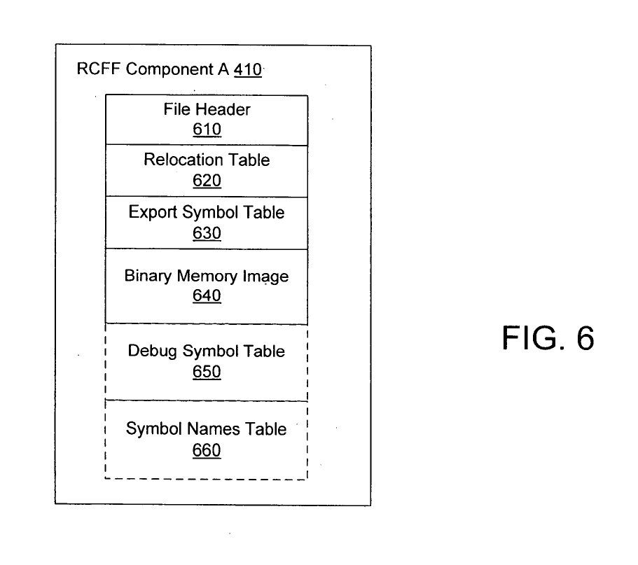

FIG. 6 illustrates further detail of the RCFF component A 410 of FIG. 4, in one embodiment in accordance with the present invention. The RCFF component A 410 includes a file header section 610 that acts as a directory to the remaining sections 620-660. A relocation table section 620 identifies locations for machine code instructions in the binary memory image section 640 that may be fixed up by the component manager 440, along with information on a processor-specific method for fixing up machine code instructions. Machine code instructions which make reference to imported symbols are encoded in the relocation table section 620 as symbolic identifiers, which may comprise 32-bit CRC codes. Machine code instructions which make reference to internal locations within the binary memory image section 640 are encoded in the relocation table section 620 as offsets into the binary memory image section 640. An export symbol table section 630 identifies a symbolic identifier, which may comprise a 32-bit CRC code, to exported symbols so that the component manager 440 can readily calculate the runtime addresses of these symbols upon request from the game software 310. A binary memory image section 640 includes all executable code, data (initialized and uninitialized), string constants, and the like, that comprise the usable contents of the RCFF component and that may be fixed up by the component manager 440.

Optionally for debugging purposes, the RCFF component A 410 includes a debug symbol table section 650 and a symbol names table section 660. For source level debugging, the 32-bit CRC numbers included in the relocation table section 620 and the export symbol table section 630 may be of limited use. Accordingly, the debug symbol table section 650 and the symbol names table section 660 provide names of the symbols. In other words, the 32-bit CRC code in the debug symbol table section 650 is not a representation of the symbol name string, but rather is an offset into the symbol names table section 660 where the actual symbol name string is stored.

The sections 610-660 of the RCFF component A 410 are described further herein as C language style arrays of structures, such that each structure in the array is aligned within the main memory 210. For ease of access by the component manager 440, the sections 610-660 may be aligned in the main memory 210 relative to the start of the RCFF component A 410. For example, 16-bit data may be aligned to a 16-bit boundary, 32-bit data may be aligned to a 32-bit boundary, and 64-bit data may be aligned to a 64-bit boundary. Pad members may be added to the structure for alignment of the next field or the next structure in the array, and pad bytes may be inserted before the start of each of the sections 610-660 for alignment of the array in the main memory 210.

The File Header Section 610

The file header section 610 comprises the first section of the RCFF component A 410 and is of fixed length. The file header section 610 specifies the offset and size of each of the sections 620-660, and serves as a directory from which the other sections 620-660 are located and accessed by the component manager 440.

Based on the overall size of the RCFF component A 410, the file header section 610 may contain 16-bit fields, 32-bit fields, or 64-bit fields. For example, if the RCFF component A 410 is smaller than 64K bytes, then 16-bit fields are adequate. Conversely, if the RCFF component A 410 is larger than 4 G bytes, then 64-bit fields may be used. The overall size of the RCFF component A 410 may also depend upon the target platform and processor (e.g., the CPU 220) in the system 200.

The following C language structure describes the file header section 610, with “NN” replaced by 16, 32, or 64, corresponding respectively to 16-bit, 32-bit, or 64-bit fields:

typedef struct _rcffNNFileHeader {

| | | |
|---|---|---|
| uint8 | fh_ident[8]; | // identifier array |
| uintNN | fh_numrelocs; | // number of relocation table records |
| uintNN | fh_relocsoff; | // file offset of relocation table |
| uintNN | fh_numexports; | // number of export symbol table |
| | | records |
| uintNN | fh_exportsoff; | // file offset of export symbol table |
| uintNN | fh_imagesize; | // size of binary memory image |
| uintNN | fh_imageoff; | // file offset of binary memory image |
| uintNN | fh_numdebugs; | // number of debug symbol table records |
| uintNN | fh_debugsoff; | // file offset of debug symbol table |
| uintNN | fh_sizenames; | // size of symbol name section |
| uintNN | fh_namesoff; | // file offset of symbol name section |

} rcffNNFileHeader;

The file header section 610 begins with an array of eight 8-bit fields called the fh-ident[ ] member. The fh-ident[ ] member determines how the component manager 440 will interpret the sections 620-660 of the RCFF component A 410. Each element in the fh-ident[ ] array is defined by the following constants:

| | | |
|---|---|---|
| #define RCFF_FHID_MAG0 | 0 | // ASCII ‘R’ |
| #define RCFF_FHID_MAG1 | 1 | // ASCII ‘C’ |
| #define RCFF_FHID_MAG2 | 2 | // ASCII ‘F’ |
| #define RCFF_FHID_MAG3 | 3 | // ASCII ‘F’ |
| #define RCFF_FHID_MAG4 | 4 | // null |
| #define RCFF_FHID_PLATFORM | 5 | // platform/processor identifier |
| #define RCFF_FHID_DATASIZE | 6 | // section data size |
| #define RCFF_FHID_FLAGS | 7 | // flags |

The array elements fh_ident[RCFF_FHID_MAG0] to fh_ident[RCFF_FHID_MAG4] contain the ASCII characters “RCFF” to identify the RCFF component A 410 as an RCFF format file. The terminating zero byte in the array element fh_ident[RCFF_FHID_MAG4] allows the use of C style string comparison functions.

The array element fh_ident[RCFF_FHID_PLATFORM] defines the target platform and processor for the RCFF component A 410. For example:

RCFF_PLATFORM_I86 = 0 =32-bit Intel x86 processor
RCFF_PLATFORM_CPU = 1 = CPU 220 processor
RCFF_PLATFORM_MIPS = 2 = MIPS processor

The array element fh_ident[RCFF_FHID_DATASIZE] defines the bit-size of fields in the file header section 610, the relocation table section 620, the export symbol table section 630, and the debug symbol table section 650. The bit-size for a particular section may be obtained by an AND of the value of this field with one of the following constants:

| | | |
|---|---|---|
| #define RCFF_DATASIZE_FHMASK | 0x03 | // file header data size |
| #define RCFF_DATASIZE_RRMASK | 0x0C | // relocation table data |
| | | size |
| #define RCFF_DATASIZE_ESMASK | 0x30 | // export symbol table |
| | | data size |
| #define RCFF_DATASIZE_DSMASK | 0xC0 | // debug symbol table |
| | | data size |

Once the fh_ident[RCFF_FHID_DATASIZE] field has been masked, the bit-size of the corresponding section 620-660 is determined by comparison with one of the following constants:

| | | |
|---|---|---|
| #define RCFF_DATASIZE_FH16 | 0x0 | // 16-bit file header |
| | | section 610 |
| #define RCFF_DATASIZE_FH32 | 0x01 | // 32-bit file header |
| | | section 610 |
| #define RCFF_DATASIZE_FH64 | 0x02 | // 64-bit file header |
| | | section 610 |
| #define RCFF_DATASIZE_RR16 | 0x00 | // 16-bit relocation table |
| | | section 620 |
| #define RCFF_DATASIZE_RR32 | 0x04 | // 32-bit relocation table |
| | | section 620 |
| #define RCFF_DATASIZE_RR64 | 0x08 | // 64-bit relocation table |
| | | section 620 |
| #define RCFF_DATASIZE_ES16 | 0x00 | // 16-bit export symbol |
| | | table section 630 |
| #define RCFF_DATASIZE_ES32 | 0x10 | // 32-bit export symbol |
| | | table section 630 |
| #define RCFF_DATASIZE_ES64 | 0x20 | // 64-bit export symbol |
| | | table section 630 |
| #define RCFF_DATASIZE_DS16 | 0x00 | // 16-bit debug symbol table |
| | | section 650 |
| #define RCFF_DATASIZE_DS32 | 0x40 | // 32-bit debug symbol table |
| | | section 650 |
| #define RCFF_DATASIZE_DS64 | 0x80 | // 64-bit debug symbol table |
| | | section 650 |

The array element fh_ident[RCFF_FHID_FLAGS] is a collection of bit flags, tested by an AND with one of the following constants:

| | |
|---|---|
| #define RCFF_FLAGS_BIGENDIAN 0x01 | // set if big-endian fields |
| | // clear if little-endian |
| | fields |

The array element fh_numrelocs specifies the number of records in the relocation table section 620. The relocation table section 620 is optional, and may not be included if the RCFF component A 410 contains only data and no executable code, or if the RCFF component A 410 contains position-independent executable code (i.e., relative addressing modes). The array element fh_numrelocs is zero if the RCFF component A 410 does not contain a relocation table section 620.

The array element fh_relocsoff specifies the offset of the relocation table section 620 in bytes from the beginning of the RCFF component A 410. The array element fh_relocsoff is zero if the RCFF component A 410 does not contain a relocation table section 620.

The array element fh_numexports specifies the number of records in the export symbol table section 630.

The array element fh_exportsoff specifies the offset of the export symbol table section 630 in bytes from the beginning of the RCFF component A 410.

The array element fh_imagesize specifies the size in bytes of the binary memory image section 640 of the RCFF component A 410.

The array element fh_imageoff specifies the offset in bytes of the binary memory image section 640 relative to the beginning of the RCFF component A 410.

The array element fh_numdebugs specifies the number of records in the debug symbol table section 650. The debug symbol table section 650 is optional, and is generally included in a debugging version of the RCFF component A 410. The array element fh_numdebugs is zero if the RCFF component A 410 does not contain the debug symbol table section 650.

The array element fh_debugsoff specifies the offset in bytes of the debug symbol table section 650 relative to the beginning of the RCFF component A 410. The array element fh_debugsoff is zero if the RCFF component A 410 does not contain the debug symbol table section 650.

The array element fh_sizenames specifies the size in bytes of the optional symbol names table section 660. The symbol names table section 660 is optionally included in a debugging version of the RCFF component A 410. The array element fh_sizenames is zero if the RCFF component A 410 does not contain the symbol names table section 660.

The array element fh_namesoff specifies the offset in bytes of the symbol names table section 660 relative to the beginning of the RCFF component A 410. The array element fh_namesoff is zero if the RCFF component A 410 does not contain the symbol names table section 660.

The Relocation Table Section 620

In some embodiments the executable portion of the binary memory image section 640 of the RCFF component A 410 contains only position-independent code. In other words, references in the executable portion of the RCFF component A 410 are to main memory 210 locations within the RCFF component A 410 that are relative to the current program counter value and not to external references. In this case, the binary memory image section 640 may be moved by the component manager 440 to any valid memory address within the main memory 210 as a block, and the binary memory image section 640 may execute without requiring modification.

Generally, however the executable portion of the binary memory image section 640 is not position-independent, because generating position-independent code may require careful planning and/or assembly language programming. As such, it may be impractical or impossible to produce an executable module such as the RCFF component A 410 consisting only of position-independent code using the compilers, linkers, and operating system on which the executable module will run. Further, different processors use different methods for encoding absolute memory locations in instructions, which methods may depend on the size of the address bus (e.g., the memory bus 280 of FIG. 2), a subdivision of memory into blocks, pages, or segments, or the specific machine code instruction being used.

Accordingly, the relocation table section 620 of the RCFF component A 410 defines methods for identifying a relocation target (machine code) instruction, what the instruction references, and the processor-specific manner in which the reference is encoded. In some embodiments, relocation target instructions within an RCFF component A 410 do not use implicit addends, by which the address being referenced is encoded in two parts, with a section identifier in the relocation table section 620 and an offset into the specified section encoded into the relocation target instruction. The use of implicit addends results in the component manager 440 overwriting (and thereby obliterating) the encoded section offset during the fixup process, making it impossible to relocate the RCFF component A 410 without reloading it. By comparison, many implementations of dynamically linked libraries in the prior art use implicit addends, making the executable component relocatable only at the time it is initially loaded into the main memory 210.

The relocation table section 620 contains an entry for each relocation target, including a symbolic identifier, an offset value, and a method code. The relocation table section 620 can be treated as an array of structures which describe the contents of the relocation table section 620. The following C language structure can be used to describe a record in the relocation table section 620, where “NN” is replaced by 16, 32, or 64 corresponding respectively to 16-bit, 32-bit, or 64-bit fields:

| typedef struct _rcffNNReloc { | |
|---|---|
| uintNN rr_ident; | // symbolic identifier |
| uintNN rr_offset; | // offset of target in binary image |
| uintNN rr_method; | // processor specific method code |

} rcffNNReloc;

The value rr_ident specifies a symbolic identifier. For an internal relocation target (i.e, one whose target instruction references a location within the binary memory image section 640), the symbolic identifier value rr_ident contains the offset of the location in the binary memory image section 640. If the relocation target is external (i.e., one whose target instruction references an imported symbol by name), then the symbolic identifier will contain a 32-bit CRC code generated from the imported symbol name. For debugging purposes, if the RCFF component A 410 contains a symbol names table section 660, then the symbolic identifier in value rr_ident will be the offset of the symbol name in the symbol names table section 660, rather than the 32-bit CRC code. The component manager 440 may still construct a 32-bit CRC code from the symbol name string in the symbol names table section 660 to improve performance.

In one embodiment, the symbolic identifier is stored as a 32-bits wide value, even where 16-bit or 64-bit fields are specified in the file header section 610. For relocation targets with 16-bit fields specified in the file header section 610, a full 32-bit field is provided for the symbolic identifier. For relocation targets with 32-bit and 64-bit fields specified in the file header section 610, either 32-bit or 64-bit fields are provided for the symbolic identifier, respectively. For external relocation targets, with no symbol names table section 660 provided, a 32-bit CRC is stored in 32-bit fields, and 32-bit CRC is stored in the least significant 32-bits of a 64-bit field. For internal relocation targets, or external relocation targets with the symbol names table section 660 provided, with 16-bit fields specified in the file header section 610, the least significant 16-bits are used. For 32-bit or 64-bit fields, 32-bits or 64-bits are used, respectively.

The value rr_offset specifies the offset of the relocation target in the binary memory image section 640. If the absolute address is encoded as part of a machine code opcode (i.e., as a bit-field), then the value rr_offset contains the offset of the opcode. Alternatively, if the absolute address is contained in a separate operand apart from the opcode, then the value rr_offset contains the offset of the operand. The value rr_method specifies a processor-specific code to determine whether the relocation target references an internal or external memory location, and the method used to encode the address of the reference. The values of rr_method is defined for each processor architecture for which RCFF components are supported.

The Export Symbol Table Section 630

The export symbol table section 630 contains records which describe symbols which are meant to be accessed by program code external to the RCFF component A 410. Exported symbols may refer to functions, variables, or initialized data. The component manager 440 accesses the export symbol table section 630 so that external code calling the RCFF component A 410 may access the symbols.

The export symbol table section 630 may be treated as an array of three structures. The following C language structure can be used to describe a single 16-bit record in the export symbol table section 630:

typedef struct _rcff16Export {

| | |
|---|---|
| uint32 es_ident; | // symbolic identifier |
| uint16 es_offset; | // offset in binary memory image section 640 |
| uint16 pad; | // alignment pad for alignment of the next |
| | structure in the array |

} rcff16Export;

Alternatively, the following C language structure can be used to describe a NN-bit record in the export symbol table section 630 (where “NN” is 32 or 64):

typedef struct _rcffNNExport {

| | |
|---|---|
| uintNN es_ident; | // symbolic identifier |
| uintNN es_offset; | // offset in binary memory image section 640 |
| } rcffNNExport; | |

The value es_ident specifies a symbolic identifier which may comprise a 32-bit CRC (cyclic redundancy check) code generated from an original symbol name string, or an offset value representing another location in the RCFF component A 410. For an external relocation target, the value es_ident contains the 32-bit CRC identifier of the imported symbol generated from the original symbol name string.

If the 32-bit CRC is generated from an original symbol name string, the symbolic identifier is 32-bits wide, even for 16-bit or 64-bit fields. If the symbolic identifier contains the offset value, and 16-bit fields are specified in the file header 610, then the least significant 16-bits are used. For 32-bit or 64-bit fields, the symbolic identifier contains the offset value specified as a 32-bit or 64-bit number.

The value es_offset specifies the offset of the location in the binary memory image section 640 represented by the symbol name.

The Binary Memory Image Section 640

The binary memory image section 640 contains an image of the executable code and data of the RCFF component A 410 as it will appear in the main memory 210 before relocation. The image includes the executable code, uninitialized data storage, initialized data storage, and any other data which comprises the RCFF component A 410 memory image at load time. The format of the contents of the binary memory image section 640 depends on the target platform and processor (e.g., the CPU 220).

By including storage for uninitialized data in the binary memory image section 640, executable code and data are encapsulated in a single block of the main memory 210, which greatly simplifies relocation of the RCFF component A 410 by the component manager 440. Further, including storage for uninitialized data in the binary memory image section 640 simplifies management of the main memory 210, since the component manager 440 only needs to determine if the RCFF component A 410 will fit into available contiguous space in the main memory 210 before loading the RCFF component A 410.

For example, the uninitialized data may be an array of 6000 elements defined in a library element. In the prior art, a loader allocates memory for those 6000 elements, and fixes up the executable code that refers to that array. If the library element is deleted when it is no longer needed, the executable code and the array of the library element are removed from memory, fragmenting both the instruction space and the data space in memory.

In contrast, the RCFF component A 410 includes initialized and uninitialized data in the binary memory image section 640. Therefore, if the RCFF component A 410 is removed when it is no longer needed, the initialized and uninitialized data and the instructions referring to them are removed, reducing fragmentation of the main memory 210 to a single “hole”. Since it is possible to relocate and fixup any remaining RCFF components in memory, the hole can be eliminated by repacking allocated memory blocks in the main memory 210, restoring the available memory to a single contiguous block. The recovery of memory to this degree was not possible in the prior art because relocation information is either not retained in memory after the relocatable executable file is loaded, or is overwritten during the fixup process.

It should be noted that the inclusion of all data in the binary memory image section 640 does not preclude the use of RCFF components with processors which have separate instruction and data memories, commonly referred to as the “Harvard” architecture processors, such as digital signal processors. When RCFF components are used with a Harvard architecture processor, the component manager 440 may copy data from the instruction memory to the data memory upon initial loading of the RCFF component, or use separate RCFF components for instructions and data.

The Debug Symbol Table Section 650

The debug symbol table section 650 provides symbolic information to an external debugger, to allow source-level debugging of RCFF components under development. The debug symbol table section 650 provides a means for getting debug information out of the RCFF component A 410 and into the external debugger. The actual format of the debug information depends on the platform and debugging tool. For example, the debug symbol table 650 may provide strings from the symbol names table section 660 for use in debugging, or provide references to the source file and line number for specific blocks of machine code instructions, etc.

The Symbol Names Table Section 660

The symbol names table section 660 is optionally provided in the RCFF component A 410 for debugging. The symbol names table section 660 contains a list of C language style null-terminated strings beginning with a single null byte which represents an empty string. Each string contains the name of a symbol, which may be imported symbols referenced in the relocation table section 620, exported symbols defined in the export symbol table section 630, or internal symbols defined in the debug symbol table section 650. The symbol names table section 660 is treated as a byte stream and individual strings are referenced by their offset in the symbol names table section 660.

The symbol names table section 660 changes the way that symbolic identifiers are used in the RCFF component A 410. A symbolic identifier which would have contained a 32-bit CRC code will, instead, contain an offset into the symbol names table section 660. The CRC code can, if necessary, be generated from the string in the symbol names table section 660.

The Component Manager 440

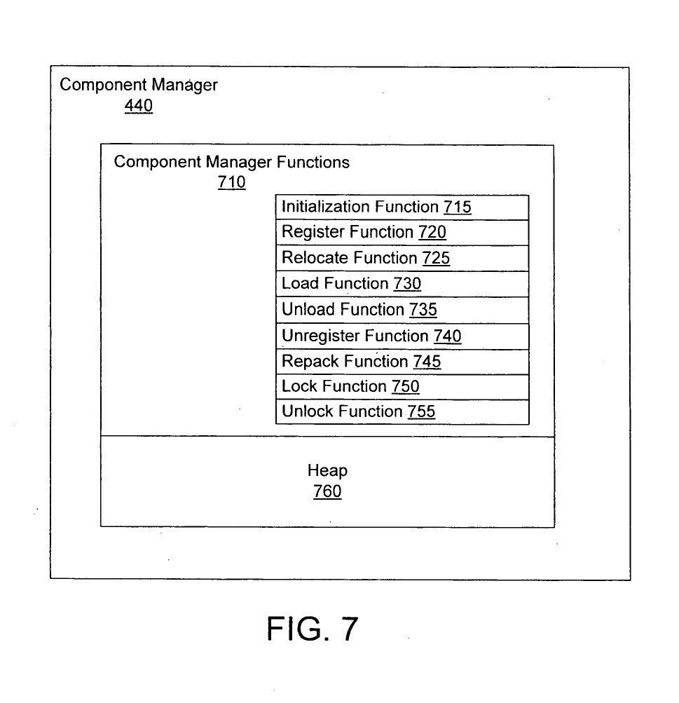

FIG. 7 illustrates the component manager 440 of FIG. 4, in one embodiment in accordance with the present invention. The component manager 440 provides for dynamic loading and linking at runtime by resolving a reference into an RCFF component (e.g. the RCFF component A 410) from an application program such as the game software 310. The component manager 440 resolves internal and external references, and performs relocation of the RCFF components A 410-C 430. As described herein, the component manager 440 may control access to RCFF components. Alternatively, an application program may control access to an RCFF component, and coordinate with the component manager 440 so that other application programs may access the RCFF component.

The component manager 440 includes a table (not shown) used to correlate a symbol name for all external symbols which any RCFF component may reference with its physical address in the main memory 210. The table may be produced by generating a text file containing a list of symbols imported by the RCFF components by name, for example:

printf

strcat

MyAppFunction

The table is used to produce a C language source file containing an initialized array that is compiled and linked with the component manager 440. For example:

| typedef struct _ImportSymbols { | | |
|---|---|---|
| uint32 | name; | // symbol name identifier |
| void* | symbol; | // symbol address |

```
} ImportSymbols;
ImportSymbols impSymbols[ ] = {
    {0x63D59852, printf},
    {0x21CDCBCD, strcat},
    {0x49461D0, MyAppFunction}
};
```

The component manager 440 uses the resulting array to look up symbols which are imported by an RCFF component and resolve the address of each symbol. Alternatively, the component manager 440 may load an RCFF component without recompiling the imported symbols by using a list containing all symbols which might be imported by any of the RCFF components.

As shown in FIG. 7, the component manager 440 includes a component manager functions module 710 and a heap 760. An initialization function 715 allocates space at the bottom of the heap 760 to create an array for managing the RCFF components that are resident in memory.

A register function 720 registers RCFF components in the heap 760 for application programs (e.g., the game software 310) that themselves manage location and relocation of RCFF components. The register function 720 creates a record in the heap 760 to keep track of the location of an RCFF component. The register function 720 provides a mechanism to coordinate the application program and the component manager 440 with respect to a location for the RCFF component.

For example, if the game software 310 desires access to a function or data in the RCFF component A 410, the component manager 440 looks up the current location for the RCFF component A 410 in the heap 760, calculates the address of the function or data within the RCFF component A 410, and returns the address to the game software 310. If the game software 310 relocates the RCFF component A 410 in the main memory 210, the game software 310 calls the register function 720 of the component manager 440 with the new location for the RCFF component A 410. The game software 310 then calls the relocate function 725 to fixup relocation targets within the RCFF component A 410. Thereafter, the game software 310 may refer to functions or data within the RCFF component A 410 with a call to the component manager 440.

As described, the component manager 440 may manage the RCFF components directly. The component manager 440 allocates the heap 760 such that the heap 760 may contain all RCFF components that may be loaded by application programs. A load function 730 allocates space in the heap 760, loads the RCFF components into the heap 760, and calls relocate function 725 to fixup the relocation targets within the RCFF components.

If the load of an RCFF component fails due to a lack of a sufficiently large available block of memory within the heap 760, a repack function 745 allows an application program to instruct the component manager 440 to move all of the RCFF components currently in the heap 760 as far downward as possible within the available memory. The repack function 745 allows the application program to defragment and recover free available space in the heap 760. After repacking, the application program may call the load function 730 to attempt to load the RCFF component again. An unload function 735 makes memory available in the heap 760 by removing an RCFF component.

An application program such as the game software 310 which is loading RCFF components into main memory 210, rather than using the load function 730 to load RCFF components into the heap 760, may need to unload RCFF components from main memory 210 at some point. An unregister function 740 allows the application program to remove an RCFF component from the main memory 210, and notify the component manager 440 that the previously registered component is no longer in memory. For an RCFF component that should not be moved, for example because the RCFF component is waiting for a callback from the operating system or waiting for an interrupt, a lock function 750 prevents the RCFF component from being moved within the main memory 210. Accordingly, an unlock function 755 allows an RCFF component to be moved within the main memory 210. The lock function 750 and unlock function 755 allow application programs to coordinate access to functions in the RCFF components. In a multi-threaded operating system environment, the lock function 750 can be called before accessing a function or data within an RCFF component, and the unlock function 755 can be called after accessing a function or data within an RCFF component, in order to prevent the RCFF component from being moved by code running within another thread.

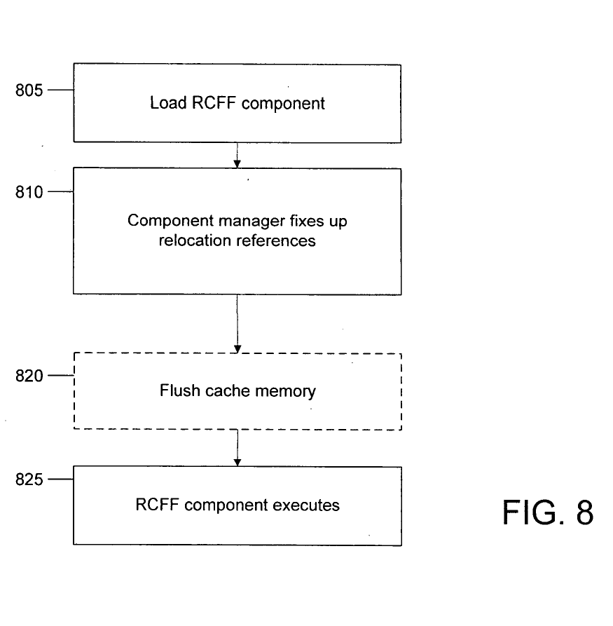

FIG. 8 illustrates a method for loading and running the RCFF component A 410 using the component manager 440 of FIG. 4, in one embodiment in accordance with the present invention. At step 805, the RCFF component A 410 is loaded into the main memory 210 at a specific location by the component manager 440

At step 810, the component manager 440 fixes up all of the references and instructions in the RCFF component A 410 which are indicated by the relocation table section 620. The component manager 440 walks through the relocation table section 620 and fixes up each reference in order. If the reference is internal (i.e., it refers to a location within the binary memory image section 640) then the relocate function 725 computes the runtime address of the reference using the base address of the RCFF component A 410 and the offset from the relocation table section 620. If the reference is external (i.e., it refers to a location outside of the RCFF component A 410) then the relocate function 725 scans the initialized import symbol table for a matching 32-bit CRC code to obtain the runtime address.

The relocation table section 620 contains a list of every location in the RCFF component A 410 to be fixed up and the processor-specific method for how to fix up that location. For an internal reference referring to a location in the binary memory image section 640, the relocate function 725 of the component manager 440 fixes up the reference by computing the location of the base address of the RCFF component A 410 in the main memory 210 and the offset of the reference into the binary memory image section 640. For an external reference referring to a location in the main memory 210, the component manager 440 fixes up the reference by searching for a matching CRC code in the import symbol table contained within the component manager 440 (described with respect to FIG. 7), and uses the corresponding runtime address from the import symbol table. A difference from the prior art is that information needed for relocation is not stored in the binary memory image section 640, such as by implicit addends, otherwise the relocation information contained in the implicit addends within the binary memory image section 640 may be obliterated upon relocation of the RCFF component A 410, such that it would not be possible to move the component A 410 in memory without reloading it.

Optionally at step 820, cache memory for the processor that will execute the RCFF component A 410 (e.g., the CPU 220) is flushed because the component manager 440 has been manipulating machine code instructions in memory. The term “flushed” indicates that locations within the cache which have been modified are written back to memory immediately. Step 820 may be performed for any processor with an instruction and/or data cache, because otherwise the cache(s) may contain incorrect instructions or data (e.g., the main memory 210 may not contain the modified machine code instructions as they may still reside in the data cache, and the instruction cache may still contain machine code instructions which previously occupied the main memory 210 locations which are now occupied by the RCFF component A 410). At step 825, the memory locations in the RCFF component A 410 have been completely fixed up and the RCFF component A 410 executes.

Alternatives and Optimizations

Although depicted as a software element, it will be appreciated that the component manager 440 may comprise any combination of hardware, software, and/or firmware elements. For example, the component manager of some embodiments includes a hardware comparator to speed the comparison of symbol names and CRC codes, and a dedicated hardware table (e.g., RAM) for maintaining RCFF component location information.

In some embodiments, an application program such as the game software 310 may initially access an RCFF component such as the RCFF component A 410 by requesting the location for the RCFF component A 410 from the component manager 440. Thereafter, the game software 3 10 may cache the location information in the main memory 210 for the RCFF component A 410. The RCFF component A 410 will be effectively locked in place by the game software 310 saving the address of the RCFF component A 410. Alternatively, the game software 310 may request the component manager 440 to lock the RCFF component A 410 in place using the lock function 750 (FIG. 7), for example because the game software 310 will be using the address of the RCFF component A 410 as a static address (e.g., as the address of a callback function or interrupt handler).

Locking the RCFF component A 410 in place may be advantageous, for example because the game software 310 does not need to load any more RCFF components. For example, if there are 50 RCFF components loaded in the main memory 210, and the game software 310 requires the RCFF component A 410 to remain in the same place in memory, the game software 310 may either cache the RCFF component A 410 address, or request the component manager 440 to lock the RCFF component A 410 in place, while other RCFF components are relocatable. In this way, the game software 310 may be superior or subordinate to the component manager 440 with respect to a location for the RCFF component A 410. The preferred method is for the game software 310 to load RCFF components which the game software 310 intends to keep in a locked state before those RCFF components which the game software 310 intends to maintain in a relocatable state, since this will result in the locked RCFF components occupying lower addresses in the heap 760, and reduce the likelihood of creating unrecoverable memory fragments in the heap 760.

With respect to exported symbols, symbols exported by an RCFF component may be handled in one of two ways. The first method includes calling the component manager function with the name of the RCFF component and symbol, and having the component manager return the address of the symbol. This method works with symbols of any type, including functions and data symbols, and allows an application program to define a standard interface for RCFF components, with each RCFF component exporting the same set of functions.

A second method includes calling a function in an RCFF component by name without first calling the component manager to obtain the address of the function, for example by providing a stub function having the same name, and then calling the component manager from within the stub function to get the address of the RCFF component function. For example, the game software 310 may include a stub function called “getbuttons” that determines whether a fire button on a game console was pressed by a user. Getbuttons is configured to call the component manager 440 and determine whether the address of the RCFF component A 410 is current, whether the RCFF component A 410 is locked, etc., and correspondingly call the desired function in the RCFF component A 410 to determine the status of the fire button. The game software 310 and other application programs may be oblivious to the fact that getbuttons isn't really getting the status of the fire button, but is instead calling the RCFF component A 410 that is getting the status of the fire button.

Stub functions may also be incorporated within RCFF components. For example, the stub function may provide relative addressing and short branch calls. Providing stub functions within RCFF components reduces the number of external relocations to be fixed up by the component manager 440 when the RCFF component would otherwise make multiple calls to the same external functions or data.

Although not depicted, multiple instances of the component manager 440 may be incorporated into an application program. For example, the application program may include a first component manager 440 for managing an audio sound library, with a second component manager 440 for managing a second heap 760 of input controllers. The application program may be programmed in a way that is completely oblivious to the use of relocatable components with the first and second component managers. Further, the application program may include a version of a component manager within the application program. Additionally, the application program may allow for multiple runtime instances of an RCFF component to exist without replicating the code from the RCFF component in memory, because the runtime instance data is allocated dynamically.

The invention has been described above with reference to specific embodiments. It will, however, be evident that various modifications and changes may be made thereto without departing from the broader spirit and scope of the invention as set forth in the appended claims. The foregoing description and drawings are, accordingly, to be regarded in an illustrative rather than a restrictive sense.

What is claimed is:

1. A method, comprising:
calling a component in a calling function of an application program executing on a processor;
passing information related to the component to a component manager;
determining the location of the component in a memory coupled to the processor; and
returning the location of the component to the calling function.

2. The method of claim 1, further comprising relocating the component in the memory before determining the location of the component.

3. The method of claim 1, further comprising loading a second component into the memory.

4. The method of claim 1, wherein relocating the component comprises defragmenting the memory.

5. The method of claim 1, wherein the information related to the component comprises a symbol name in the component.

6. The method of claim 5, further comprising comparing the symbol name to a cyclic redundancy check code corresponding to the symbol name in the component manager.

7. The method of claim 1, further comprising locking the location of the component in the memory.

8. The method of claim 1, further comprising registering the location of the component with the component manager.

9. The method of claim 1, wherein the component comprises initialized and uinitialized data.

10. A method, comprising:
calling, in a calling function of an application program executing on a processor, a reference within a component;
passing information related to the component to a component manager;
determining the location of the reference; and
returning the location of the reference to the calling function.

11. The method of claim 10, wherein calling the reference comprises calling a symbol name and wherein determining the location of the reference comprises comparing the symbol name to a symbolic identifier associated with the symbol name.

12. The method of claim 11, wherein the symbolic identifier comprises a cyclic redundancy check code.

13. The method of claim 10, wherein the location of the reference is determined based upon an address for the component and an offset from the address to the reference.

14. The method of claim 10, wherein the application program determines the location of the reference and passes information related to the reference to the component manager.

15. The method of claim 10, wherein the component comprises initialized and uninitialized data.

16. A computer program product comprising application program code for performing a method to be executed on a processor, the method comprising:
calling a reference of a component with a calling function of the application program;
passing information related to the reference to a component manager;
determining the location in a memory coupled to the processor of the reference in the component; and
returning the location of the reference to the calling function.

17. The method of claim 16, wherein the location of the reference is determined based upon an memory address for the component and an offset of the reference in the component.

18. The method of claim 16, wherein the application program determines the location of the reference and passes information related to the reference to the component manager.

19. The method of claim 16, wherein the component comprises initialized and uninitialized data.

20. A system, comprising:
a memory;
a processor configured to execute an application program stored in the memory, the application program including a calling function configured to call a component stored in the memory; and
a component manager, the component manager configured to determine a memory address of the component and return the memory address to the calling function.

21. The system of claim 20, wherein the component manager is further configured to relocate the component in the memory.

22. The system of claim 20, wherein the component manager is further configured to load the component into the memory.

23. The system of claim 20, wherein the component manager is further configured to defragment the memory.

24. The system of claim 20, wherein the application program is configured to manage the location of the component in memory and inform the component manager of the location.

25. The system of claim 24, wherein the component manager is configured to prevent another application program from moving the component in memory.

26. A system, comprising:
a memory;
a processor configured to execute an application program stored in the memory, the application program including a function configured to call a component stored in the memory; and
means for returning to the calling function the location of the component in the memory.

27. The system of claim 26, further comprising means for relocating the component in the memory.

28. The system of claim 26, further comprising means for loading the component in the memory.

29. The system of claim 26, further comprising means for defragmenting the memory.
